(19) United States
(12) Patent Application Publication
(10) Pub. No.: US 2020/0257675 A1
(43) Pub. Date: Aug. 13, 2020

(54) METHOD, APPARATUS, AND SYSTEM FOR EVALUATING A PARTITION IN A DATABASE

(71) Applicant: ALIBABA GROUP HOLDING LIMITED, George Town (KY)

(72) Inventors: Chuangxian WEI, Hangzhou (CN); Jiye TU, Hangzhou (CN); Jienan ZENG, Hangzhou (CN); Jin HU, Hangzhou (CN)

(21) Appl. No.: 16/860,872

(22) Filed: Apr. 28, 2020

Related U.S. Application Data
(63) Continuation of application No. PCT/CN2018/111172, filed on Oct. 22, 2018.

(30) Foreign Application Priority Data
Nov. 2, 2017 (CN) 201711063844.0

(51) Int. Cl. G06F 16/23; G06F 16/2455

(52) U.S. Cl. CPC G06F 16/2365; G06F 16/24553

(57) ABSTRACT

Embodiments of the present disclosure can provide a method and an apparatus for evaluating a partition in a database. The method can include: acquiring meta information of a data partition in the database, wherein the meta information comprises an area range value of the data partition; and determining whether the data partition is a valid partition according to a query condition of a query associated with the data partition and the meta information of the data partition.

The present disclosure claims the benefits of priority to International Application No. PCT/CN2018/111172, filed on Oct. 22, 2018, which claims priority to Chinese Patent Application No. 201711063844.0 filed on Nov. 2, 2017, both of which are incorporated herein by reference in their entireties.

### BACKGROUND

As the amount of data stored in the table space of a database continues to increase and exceeds a certain scale, data querying slows down and the performance of applications can be degraded. Therefore, partitioning of the table is used. Data in the table is split into multiple partitions (e.g., LIST partitions that specify a list of discrete values for a partitioning key in the description for each partition) according to a certain logic (the logic is usually “time”). After the table is partitioned, it is still a table logically, but the data in the table is physically stored in multiple “table spaces,” partial data being stored in each partition table. When querying the data in each table, the table is split into multiple partitions for querying. Query results of all partitions are summarized as a final result of querying the entire table. The partition table can map different partitions to a disk to balance I/O and improve the performance of the entire system.

However, query performance can be severely affected when there are a large number of partition tables. The larger the number of partition tables of one table, the worse the query performance because there are too many invalid partitions during querying.

A conventional method to avoid query of invalid partitions requires a DBA (database administrator) or a user to perceive a partition logic and manually rewrite SQL based on the partition logic. The DBA is a collective name of relevant staff engaged in the management and maintenance of a database management system (DBMS), belongs to a branch of operation and maintenance engineers, and is mainly responsible for the full life cycle management of the business database from design, testing to deployment, and delivery. When the partition logic is changed, structured query language (SQL) needs to be rewritten again, which is very error prone. SQL is a database query and programming language for accessing data and querying, updating, and managing relational data systems, and is also an extension of data scriptable files. Moreover, this method is only suitable for query optimization where a query condition is a partition column. When the query condition is a non-partition column, optimization cannot be performed. Existing solutions cannot effectively avoid query of invalid partitions, have complicated processes, and are error-prone, and thus the query efficiency still cannot be improved.

Some conventional systems provide approaches on partitioning. For example, a train schedule contains three columns, e.g., id, start time, and end time. The “start time” column is used as the basis to partition tables, and all records on the same day are saved in one partition table. When the query condition is an equivalent query or a range query of the “start time” column, a DBA or a user needs to determine, through calculation according to the partition method, the number of a partition table that meets the condition, and modify the structured query language of the database to increase screening conditions of the partition table. Moreover, when the query condition is a non-partition column, e.g., when the query condition is a range query of the “end time” column, query optimization cannot be performed.

Accordingly, current systems have difficulty in effectively avoiding invalid partition query and the low query efficiency.

### SUMMARY

Embodiments of the present disclosure can provide a method and an apparatus for evaluating a partition in a database. The method can include acquiring meta information of a data partition in the database, wherein the meta information comprises an area range value of the data partition; and determining whether the data partition is a valid partition according to a query condition of a query associated with the data partition and the meta information of the data partition.

### BRIEF DESCRIPTION OF THE DRAWINGS

The accompanying drawings described herein are used to provide further understanding of the present disclosure and constitute a part of the present disclosure. Exemplary embodiments of the present disclosure and descriptions of the exemplary embodiments are used to explain the present disclosure and are not intended to constitute inappropriate limitations to the present disclosure. In the accompanying drawings:

FIG. 1 is a schematic structural diagram of an exemplary system for evaluating a partition in a database, consistent with some embodiments of the present disclosure.

FIG. 2 is a flowchart of an exemplary method for evaluating a partition in a database, consistent with some embodiments of the present disclosure.

FIG. 3 is a flowchart of an exemplary method for evaluating a partition in a database, consistent with some embodiments of the present disclosure.

FIG. 4 is a flowchart of an exemplary method for evaluating a partition in a database, consistent with some embodiments of the present disclosure.

FIG. 5 is a flowchart of an exemplary method for evaluating a partition in a database, consistent with some embodiments of the present disclosure.

FIG. 6 is a flowchart of an exemplary method for evaluating a partition in a database, consistent with some embodiments of the present disclosure.

FIG. 7 is a schematic structural diagram of an exemplary apparatus for evaluating a partition in a database, consistent with some embodiments of the present disclosure.

FIG. 8 is a schematic diagram of a computer terminal for evaluating a partition in a database, consistent with some embodiments of the present disclosure.

### DETAILED DESCRIPTION

To facilitate understanding of the solutions in the present disclosure, the technical solutions in some of the embodiments of the present disclosure will be described with reference to the accompanying drawings. It is appreciated that the described embodiments are merely a part of rather than all the embodiments of the present disclosure. Consistent with the present disclosure, other embodiments can be obtained without departing from the principles disclosed herein. Such embodiments shall also fall within the protection scope of the present disclosure.

It should be further noted that in this text, the relation terms such as “first” and “second” are merely used to distinguish one entity or operation from another entity or operation, and do not require or imply that the entities or operations have this actual relation or order. Moreover, the terms “include,” “comprise” or any other variations thereof are intended to cover non-exclusive inclusion, so that a process, method, article or terminal device including a series of elements not only includes the elements, but also includes other elements not clearly listed, or further includes elements inherent to the process, method, article or terminal device. In the absence of more limitations, an element defined by “including a/an . . . ” does not exclude that the process, method, article or terminal device including the element further has other identical elements.

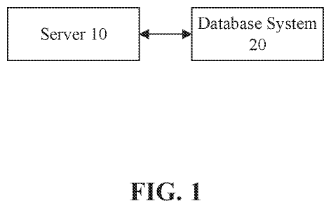

FIG. 1 is a schematic structural diagram of an exemplary system for evaluating a partition in a database, consistent with some embodiments of the present disclosure.

The exemplary system can be widely applied in the Internet. With the rapid development of the social economy, the information age has arrived. The massive data information that comes with information processing needs to be stored and processed, and the data storage structure of the database needs to be constantly designed and optimized. Specifically, when the amount of data stored in the database continuously increases and exceeds a certain scale, the speed of querying data slows down, and the performance of applications is degraded. Therefore, table partition needs to be considered and each partition table stores partial data. When querying the data in each table, it can be split into multiple partitions for querying, and all partition query results can be aggregated into a final result of querying the entire table.

However, query performance can be severely affected when there are a large number of partition tables. When the number of partition tables of a table increases, the query performance becomes worse due to too many invalid partitions during querying. Currently, a conventional solution is that a database administrator or user needs to be fully aware of a partition logic integrated business query and increase the range of partition tables in SQL. This solution is only suitable for query optimization of partition column conditions.

A system for determining a valid partition in a database is provided in this disclosure. The aim of executing query without querying an invalid partition can be achieved via the system, thereby achieving the technical effect of improving query efficiency and further solving the existing technical problems of the difficulty in avoiding invalid partition query and the consequent low query efficiency.

The system for determining a valid partition in a database provided in this disclosure can provide improvements over some conventional systems. If the query condition is “end time,” the “end time” column of each LIST partition is relatively concentrated when a difference between the end time and the start time is relatively small or relatively stable (for example, the start time is the train departure time and the end time is the train arrival time), which can achieve the technical effect of determining and pruning off a large number of invalid LIST partitions, thereby achieving the aim of improving query performance.

FIG. 1 is a schematic structural diagram of an exemplary system for evaluating a partition in a database, consistent with some embodiments of the present disclosure. As shown in FIG. 1, the system includes a server 10 and a database system 20.

The server 10 is configured to acquire meta information of a data partition in the database, wherein the meta information includes an area range value of the data partition. The meta information can provide meta information of relevant pages. A tag is located at the head of a document and contains no content. The attribute of the tag defines a name/value pair associated with the document. The database system 20 is connected to the server 10 and is configured to determine whether the data partition is a valid partition according to a query condition and the meta information of the data partition.

Optionally, the server 10 can be a cloud-end server (e.g., a cloud server), and the database system 20 can be any type of database system, for example, an analytical database system.

In addition, the database system supports massive data query, can perform real-time analysis and statistics on massive data in any dimension, and supports high-concurrency, low-latency (millisecond response) query.

It should be noted that the above data partition can be a table partition (e.g., a LIST partition), and specifically, can be a column partition. In addition, the above meta information can be meta information added when the LIST partition is created; the above area range values are maximum and minimum values of each column of data in the LIST partition.

In some embodiments, a server can implicitly establish a mapping relationship between a column value of each column of data in the LIST partition and an area number of a corresponding LIST partition by obtaining maximum and minimum values of each column of data in the table partition; furthermore, when querying data in a database table, it is not necessary for the DBA to manually modify the SQL according to a query condition, and it can be quickly determined, according to the query condition and the mapping relationship, whether the LIST partition is a valid partition.

It should be noted that in order to improve query accuracy and query efficiency, when the above query condition is a combined condition, the combined condition can be split into multiple sub-conditions. The database system performs querying based on the multiple sub-conditions in turn, and obtain a query result of the combined condition by combining query results of the sub-conditions.

Optionally, the valid partition can be a partition satisfying a query condition. If the query condition is a combined condition, the partition is determined as a valid partition when condition results of all sub-conditions in the combined condition are valid partitions.

In some embodiments, if a LIST partition is queried based on multiple sub-conditions in a combined condition, and a condition result of the combined condition is true, that is, the LIST partition satisfies the query condition, then the LIST partition is determined as a valid partition; otherwise, the LIST partition is determined as an invalid partition.

In some embodiments, after determining whether a data partition is a valid partition according to a query condition and meta information of the data partition, the database system is further configured to, if the data partition is determined as an invalid partition, directly prune off the invalid partition.

In addition, if a LIST partition is queried according to multiple sub-conditions in a combined condition and the LIST partition is determined as an invalid partition, the LIST partition is directly pruned off before querying each LIST partition and only valid partitions are queried during query execution, thereby realizing the aim of improving the query performance.

In view of the above, in this disclosure, a server is used to acquire meta information in a database, and the meta information includes an area range value of the data partition; and a database connected to the server is used to determine whether the data partition is a valid partition according to a query condition and the meta information of the data partition.

Since meta information of a data partition in the database is increased when the LIST partition is created, the meta information of the data partition in the database is acquired when query is executed. According to the meta information and a query condition, the partition number of an invalid partition that does not satisfy the condition can be determined, and the invalid partition is automatically pruned off. No DBA or user is required to be aware of the partition logic and manually change SQL, which can effectively improve query efficiency.

In some embodiments, the database system is further configured to traverse each data record in a database and acquire an area range value of each data record when data partitions of the database are created; and store the area range value of each data record into meta information of a corresponding data partition to obtain an area range value of the data partition.

It should be noted that when any LIST partition is created, each column of data records in the LIST partition can be traversed, maximum and minimum values of each column of data records are counted, and the maximum and minimum values of all columns are stored to the meta information corresponding to the LIST partition.

In addition, because the memory occupied by the maximum and minimum values is very small, the meta information can be cached in the memory in actual system applications to reduce the IO overhead in the query process.

In some embodiments, the database system is further configured to determine, in the following manner, whether a data partition is an valid partition: obtaining, if the query condition is a combined condition, at least one sub-condition included in the combined condition; acquiring a condition value of the sub-condition according to the type of the sub-condition; determining a condition result of the sub-condition by comparing the condition value of the sub-condition with the area range value of the data partition, wherein the area range value of the data partition at least includes a maximum area value and a minimum area value; and determining, based on the condition result of the at least one sub-condition, whether the data partition is a valid partition.

Specifically, the combined condition can be composed of multiple query sub-conditions. When query is executed, the combined condition needs to be split into multiple sub-conditions for independent query. The at least one sub-condition, e.g., a query sub-condition composing the combined condition, can be understood as a single condition relative to the combined condition.

Optionally, the type of the sub-condition can include, but is not limited to, an equivalent condition, a range query condition, or other types of query conditions. The condition value of the sub-condition is a determination condition value set corresponding to the type of the sub-condition.

In some embodiments, if the type of the sub-condition is an equivalent condition, it is determined whether a maximum area value or a minimum area value in a LIST partition is a condition value of the equivalent condition. If yes, it is determined that the LIST partition satisfies the equivalent condition, and a condition result of the equivalent condition is true; otherwise, it is determined that the condition result of the equivalent condition is false.

In some embodiments, if the type of the sub-condition is a range query condition, it is determined whether the maximum area value or the minimum area value in the LIST partition has an overlap with the condition value of the range query condition. If yes, it is determined that the LIST partition satisfies the range query condition, and the condition result is true; otherwise, it is determined that the condition result of the range query condition is false.

In some embodiments, the database system is further configured to determine, in the following manner, whether a data partition is an valid partition: if the query condition includes multiple sub-conditions, acquiring a condition result of each of the sub-conditions; determining, if the condition results of the sub-conditions are all true, the data partition as a valid partition; and determining, if the condition result of any one or more sub-conditions is false, the data partition as an invalid partition.

In some embodiments, after obtaining condition results of all the sub-conditions in a combined condition, the database system is further configured to combine the condition results of all the sub-conditions to obtain a condition result of the combined condition.

In some embodiments, if the obtained condition result of the combined condition is true, the LIST partition is determined as a valid partition, the LIST partition does not need to be pruned off, and partition query can be executed. In some embodiments, if the obtained combination result is false, the LIST partition is determined as an invalid partition and does not satisfy the query condition, the database system directly prunes off the LIST partition, and partition query does not need to be executed.

In some embodiments, in the process of executing query language of the database, the database system is further configured to determine sequentially whether each data partition included in the database is a valid partition, and if the currently determined data partition is determined as a valid partition, a corresponding partition query is executed; otherwise, the data partition determined as an invalid partition is pruned off, and whether a next data partition in the database is a valid partition is determined until all data partitions in the database are determined.

In some embodiments, if the type of the sub-condition is an equivalent condition, the condition value of the sub-condition is any preset value, the database system is further configured to determine the condition result of the sub-condition in the following manner: determining the condition result of the sub-condition as false if the maximum area value is less than or equal to the condition value of the sub-condition, or the minimum area value is greater than or equal to the condition value of the sub-condition; otherwise, determining the condition result of the sub-condition as true.

In some embodiments, if the type of the sub-condition is a range query condition, the condition value of the sub-condition is a preset range value. The database system is further configured to determine the condition result of the sub-condition in the following manner: determining, if there is an overlap between the preset range value and the area range value of the data partition, the condition result of the sub-condition as true; otherwise, determining the condition result of the sub-condition as false.

In, an example, the type of the sub-condition is a range query condition, and the condition value of the sub-condition is a preset range value (2, 4). If a maximum value of a column partition y is 6 and a minimum value thereof is 3, e.g., a range of the minimum value to the maximum value of the data area is (3, 6), it can be determined, by comparing the condition value of the sub-condition and the area range value of the data partition, that the area range value (3, 6) has an overlap with the preset range value (2, 4), and the condition result of the range condition is true.

In another example, the type of the sub-condition is a range query condition, and the condition value of the sub-condition is a preset range value (2, 4). If the maximum value of the column partition y is 8 and the minimum value thereof is 5, e.g., a range of the minimum value to the maximum value of the data area is (5, 8), it can be determined, by comparing the condition value of the sub-condition and the area range value of the data partition, that the area range value (5, 8) does not have an overlap with the preset range value (2, 4), and the condition result of the range condition is false.

In some embodiments, if the type of the sub-condition is neither an equivalent condition nor a range query condition, the condition result of the sub-condition is determined by the database system as true.

It should be noted that x, y, and z can be sequence numbers of the data partition and other variations.

It should be noted that the method for determining a valid partition in a database provided in some embodiments can be used in the process of querying multiple partitions in the database. No DBA is required to be aware of the partition logic and manually rewrite SQL, and the invalid partition can be automatically determined and pruned off according to a query condition and meta information in the database, thereby improving the query performance of multiple partitions in the database.

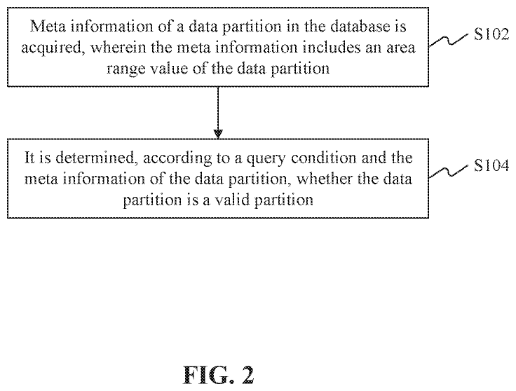

FIG. 2 is a flowchart of an exemplary method for evaluating a partition in a database, consistent with some embodiments of the present disclosure. The method includes the following steps.

In step S102, meta information of a data partition in the database is acquired, wherein the meta information includes an area range value of the data partition.

Optionally, in step S102, the data partition can be a table partition (e.g., a LIST partition), and specifically, can be a column partition. The meta information can be meta information added when the LIST partition is created, and the area range values are maximum values and minimum values of each column of data in the LIST partition.

In some embodiments, a mapping relationship between a column value of each column of data in the LIST partition and an area number of a corresponding LIST partition can be implicitly established by obtaining maximum and minimum values of each column of data in the table partition; furthermore, when querying data in a database table, it is not necessary for the DBA to manually modify the SQL according to a query condition, and it can be quickly determined, according to the query condition and the mapping relationship, whether the LIST partition is a valid partition (a partition satisfying the query condition).

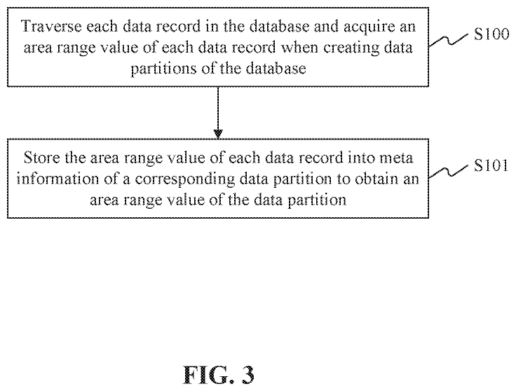

FIG. 3 is a flowchart of an exemplary method for evaluating a partition in a database, consistent with some embodiments of the present disclosure. As shown in FIG. 3, before executing step S102 of acquiring the meta information of the data partition in the database, the method further includes the following steps.

In step S100, each data record in the database is traversed and an area range value of each data record is acquired when creating data partitions of the database.

In step S101, the area range value of each data record is stored into meta information of a corresponding data partition to obtain an area range value of the data partition.

When any LIST partition is created, each column of data records in the LIST partition can be traversed, maximum and minimum values of each column of data records are counted, and the maximum and minimum values of all columns are stored to the meta information corresponding to the LIST partition.

In addition, because the memory occupied by the above maximum and minimum values is very small, the meta information can be cached in the memory in actual system applications to reduce the IO overhead in the query process.

Referring back to FIG. 2, in step S104, according to a query condition and the meta information of the data partition, whether the data partition is a valid partition is determined.

It should be noted that in order to improve query accuracy and query efficiency, when the above query condition is a combined condition, the combined condition can be split into multiple sub-conditions. Query can be performed based on the multiple sub-conditions in turn, and a query result of the combined condition is obtained by combining query results of the sub-conditions.

In some embodiments, the invalid partition can be a partition that does not satisfy the query condition of the DBA or user, and the valid partition can be a partition satisfying the query condition. The query condition can be selected and determined according to actual situations.

In some embodiments, if a LIST partition is queried based on multiple sub-conditions in a combined condition, and a condition result of the combined condition is true, that is, the LIST partition meets the query condition, then the LIST partition is determined as a valid partition; otherwise, the LIST partition is determined as an invalid partition.

In some embodiments, after determining whether the data partition is a valid partition according to a query condition and the meta information of the data partition, the method further includes: if the data partition is determined as an invalid partition, directly pruning off the invalid partition.

In addition, if a LIST partition is queried according to multiple sub-conditions in a combined condition and the LIST partition is determined as an invalid partition, the LIST partition is directly pruned off before querying each LIST partition and only valid partition is queried during query execution, thereby realizing the aim of improving the query performance.

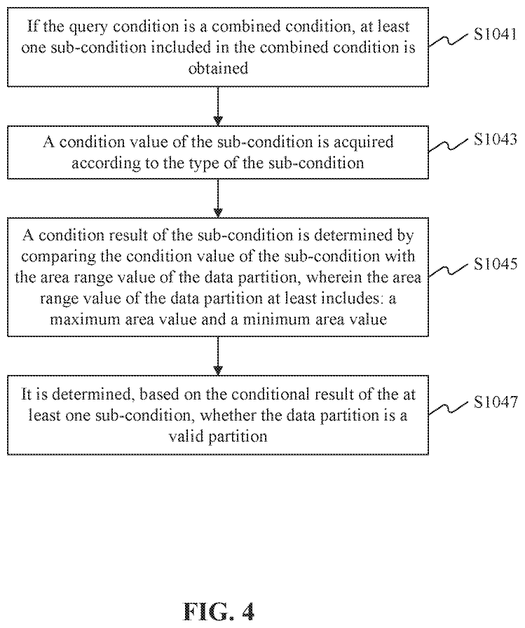

FIG. 4 is a flowchart of an exemplary method for evaluating a partition in a database, consistent with some embodiments of the present disclosure. As shown in FIG. 4, step S104 of determining whether the data partition is a valid partition according to a query condition and the meta information of the data partition in FIG. 2, can include the following steps.

In step S1041, if the query condition is a combined condition, at least one sub-condition included in the combined condition is obtained.

Specifically, the combined condition can be composed of multiple query sub-conditions. When query is executed, the combined condition needs to be split into multiple sub-conditions for independent queries. The at least one sub-condition, e.g., a query sub-condition composing the combined condition, can be understood as a single condition relative to the combined condition.

In some embodiments, for example, the combined condition is (x=5, OR 2<y<4) AND (z!=4), the combined condition can be split into the following three sub-conditions: 1: x=5; 2: 2<y<4; 3: (z!=4).

It should be noted that x, y, and z can be sequence numbers of the data partitions. The above optional embodiments regarding the combined condition and the sub-conditions are only for illustrative purposes and are not limiting. When a specific query is involved, transformation and conversion can be performed according to the query condition and the specific application environment.

In step S1043, a condition value of the sub-condition is acquired according to the type of the sub-condition.

Optionally, in step S1043, the type of the sub-condition can include but is not limited to an equivalent condition, a range query condition, or other types of query conditions. The condition value of the sub-condition is a determination condition value set corresponding to the type of the sub-condition.

In step S1045, a condition result of the sub-condition is determined by comparing the condition value of the sub-condition with the area range value of the data partition, wherein the area range value of the data partition at least includes a maximum area value and a minimum area value.

In some embodiments, if the type of the sub-condition is an equivalent condition, it is determined whether a maximum area value or a minimum area value in a LIST partition is a condition value of the equivalent condition. If yes, it is determined that the LIST partition satisfies the equivalent condition, and a condition result of the equivalent condition is true; otherwise, it is determined that the condition result of the equivalent condition is false.

In some embodiments, if the type of the sub-condition is a range query condition, it is determined whether the maximum area value or the minimum area value in the LIST partition has an overlap with the condition value of the range query condition. If yes, it is determined that the LIST partition satisfies the range query condition, and the condition result is true; otherwise, it is determined that the condition result of the range query condition is false.

The query conditions of other types are neither equivalent conditions nor sub-conditions of the range query condition, and all condition results are true.

In step S1047, it is determined based on the condition result of the at least one sub-condition whether the data partition is a valid partition.

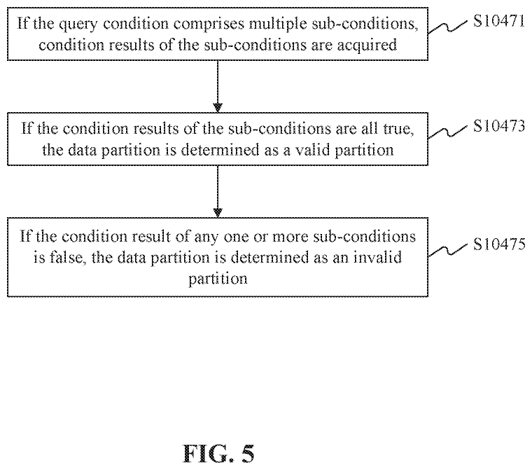

FIG. 5 is a flowchart of an exemplary method for evaluating a partition in a database, consistent with some embodiments of the present disclosure. As shown in FIG. 5, step S1047 of determining, based on the condition result of the at least one sub-condition, whether the data partition is a valid partition in FIG. 4 includes the following steps.

In step S10471, if the query condition includes multiple sub-conditions, condition results of all the sub-conditions are acquired.

In step S10473, if the condition results of the sub-conditions are all true, the data partition is determined as a valid partition.

In step S10475, if the condition result of any one or more sub-conditions is false, the data partition is determined as an invalid partition.

In some embodiments, after condition results of all the sub-conditions included in the combined condition are obtained, the condition results of all the sub-conditions are combined to obtain a condition result of the combined condition.

In some embodiments, if the obtained condition result of the combined condition is true, the LIST partition is determined as a valid partition, the LIST partition does not need to be pruned off, and partition query can be performed. In some embodiments, if the obtained combination result is false, the LIST partition is determined as an invalid partition and does not satisfy the query condition, the LIST partition is directly pruned off, and partition query does not need to be executed.

In some embodiments, in the process of executing query language of the database, it is necessary to determine sequentially whether each data partition included in the database is a valid partition, and if the currently determined data partition is determined as a valid partition, a corresponding partition query is executed; otherwise, the data partition determined as an invalid partition is pruned off, and whether a next data partition in the database is a valid partition is determined until all data partitions in the database are determined.

In some embodiments, if the type of the sub-condition is an equivalent condition, the condition value of the sub-condition is any preset value. Step S1045 of determining a condition result of the sub-condition by comparing the condition value of the sub-condition with the area range value of the data partition in FIG. 4 can include the following steps. The condition result of the sub-condition is determined as false if the maximum area value is less than or equal to the condition value of the sub-condition, or the minimum area value is greater than or equal to the condition value of the sub-condition. Otherwise the condition result of the sub-condition is determined as true.

In some embodiments, for example, the type of the sub-condition is an equivalent condition and the condition value of the sub-condition is x=5, if a maximum value of the column partition x is less than or equal to 5, or a minimum value of the column partition x is greater than or equal to 5, it can be determined that the column partition x does not meet the equivalent condition, and the condition result of the equivalent condition is false.

In some embodiments, for example, the type of the sub-condition is an equivalent condition and the condition value of the sub-condition is x=5, if a maximum value of the column partition x is greater than 5, or a minimum value of the column partition x is less than 5, it can be determined that the column partition x meets the equivalent condition, and the condition result of the equivalent condition is true.

In some embodiments, if the type of the sub-condition is a range query condition, the condition value of the sub-condition is a preset range value. E.g., step S1045 of determining a condition result of the sub-condition by comparing the condition value of the sub-condition with the area range value of the data partition, can include the following steps: determining, if there is an intersection between the preset range value and the area range value of the data partition, the condition result of the sub-condition as true; otherwise, determining the condition result of the sub-condition as false.

In some embodiments, an example in which the type of the sub-condition is a range query condition, and the condition value of the sub-condition is a preset range value (2, 4) is taken: if a maximum value of a column partition y is 6 and a minimum value thereof is 3, e.g., a range of the minimum value to the maximum value of the data area is (3, 6), it can be determined, by comparing the condition value of the sub-condition and the area range value of the data partition, that the area range value (3, 6) has an intersection with the preset range value (2, 4), the condition result of the range condition is true.

In some embodiments, an example in which the type of the sub-condition is a range query condition, and the condition value of the sub-condition is a preset range value (2, 4) is taken: if the maximum value of the column partition y is 8 and the minimum value thereof is 5, e.g., a range of the minimum value to the maximum value of the data area is (5, 8), it can be determined, by comparing the condition value of the sub-condition and the area range value of the data partition, that the area range value (5, 8) does not have an intersection with the preset range value (2, 4), the condition result of the range condition is false.

In addition, in some embodiments, if the type of the sub-condition is neither an equivalent condition nor a range query condition, the condition result of the sub-condition is determined as true.

In some embodiments, meta information of a data partition in a database is acquired, wherein the meta information includes an area range value of a data partition, and it can be determined, according to a query condition and the meta information of the data partition, whether the data partition is a valid partition.

In some embodiments, since meta information of a data partition in the database is increased when the LIST partition is created, the meta information of the data partition in the database is acquired when query is executed, and according to the meta information and a query condition, the partition number of an invalid partition that does not meet the condition can be determined, and the invalid partition is automatically pruned off; no DBA or user is required to be aware of the partition logic and manually change SQL, which can effectively improve query efficiency.

The solution provided by some embodiments of this disclosure achieves the aim of executing query without querying an invalid partition, thereby achieving the technical effect of improving query efficiency and further solving the existing technical problems of the difficulty in avoiding invalid partition query and the low query efficiency.

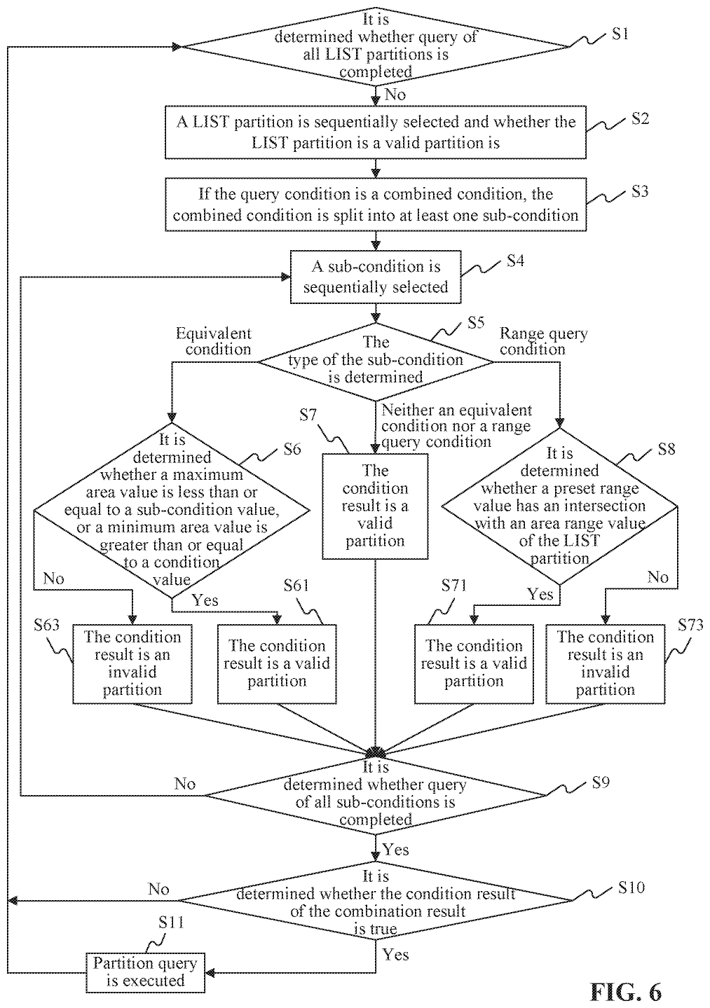

The above embodiments of this disclosure are illustrated by examples in combination with a specific implementation manner FIG. 6 is a flowchart of an exemplary method for evaluating a partition in a database, consistent with some embodiments of the present disclosure. As shown in FIG. 6, the method can include the following steps.

In step S1, it is determined whether querying of all LIST partitions is completed. Optionally, in step S1, it can be determined by SQL query languages whether the querying of all LIST partitions is completed. Specifically, if the querying of all LIST partitions is completed, the querying ends; if the querying of all LIST partitions is not completed, the method proceeds to step S2.

In step S2, a LIST partition is sequentially selected and whether the LIST partition is a valid partition is queried. Optionally, since one database can have one or more LIST partitions, when at least one LIST partition in the data is queried whether it is a valid partition, the query can be performed on partitions one by one.

Specifically, meta information of the LIST partition can be acquired, and further, whether the LIST partition is a valid partition can be determined according to a query condition and the meta information. In some embodiments, the meta information includes area range values (a maximum value and a minimum value) of the LIST partition.

In step S3, if the query condition is a combined condition, the combined condition is split into at least one sub-condition. Specifically, in step S3, the at least one sub-condition, e.g., a query sub-condition composing the combined condition, can be understood as a single condition relative to the combined condition.

In step S4, a sub-condition is sequentially selected.

In step S5, the type of the sub-condition is determined. It should be noted that in step S5, the condition value of the sub-condition can be acquired according to the type of the sub-condition. Optionally, the type of the sub-condition can include but is not limited to an equivalent condition, a range query condition, or other types of query conditions. The condition value of the sub-condition is a determination condition value set corresponding to the type of the sub-condition.

In some embodiments, if the type of the sub-condition is an equivalent condition, the condition value of the sub-condition is any preset value; and if the type of the sub-condition is a range query condition, the condition value of the sub-condition is a preset range value.

Specifically, if it is determined that the type of the sub-condition is an equivalent condition, the method proceeds to step S6; if it is determined that the type of the sub-condition is a range query condition, the method proceeds to step S7; and if it is determined that the type of the sub-condition is neither an equivalent condition nor a range query condition, the method proceeds to step S8.

In step S6, it is determined whether a maximum area value is less than or equal to a sub-condition value, or a minimum area value is greater than or equal to a condition value. Specifically, if the maximum area value is less than or equal to the condition value of the sub-condition, or the minimum area value is greater than or equal to the condition value of the sub-condition, a determination result of step S61 is obtained; otherwise, a determination result of step S63 is obtained.

In step S61, the condition result is a valid partition. Specifically, the condition result is a condition result of the equivalent condition.

In step S63, the condition result is an invalid partition. Specifically, the condition result is a condition result of the equivalent condition.

In step S7, it is determined whether a preset range value has an intersection with an area range value of the LIST partition. Specifically, the area range value is a range value of the minimum value to the maximum value of the LIST partition. Optionally, if the preset range value has an intersection with the range value of the minimum value to the maximum value of the LIST partition, a determination result of step S71 is obtained; otherwise, a determination result of step S73 is obtained.

In step S71, the condition result is a valid partition. Specifically, the condition result is a condition result of the range query condition.

In step S73, the condition result is an invalid partition. Specifically, the condition result is a condition result of the range query condition.

In step S8, the condition result is a valid partition. Optionally, in step S8, if the type of the sub-condition is neither an equivalent condition nor a range query condition, all the obtained condition results are valid partitions.

In some embodiments, at least one sub-condition is sequentially selected, and a condition value is determined according to the type of the at least one sub-condition to query the LIST partition; after the condition result of at least one sub-condition is obtained, the method proceeds to step S9.

In step S9, it is determined whether query of all sub-conditions is completed. Specifically, if it is determined that query of all sub-conditions in the combined condition is completed, the method proceeds to step S10; if it is determined that query of any one or more sub-conditions in the combined condition is not completed, the method proceeds to step S4 to continue the query of any one or more sub-conditions whose query is not completed.

In some embodiments, in the process of executing query language of the database, it is necessary to determine sequentially whether each data partition included in the database is a valid partition, and if the currently determined data partition is determined as a valid partition, a corresponding partition query is executed, otherwise, the data partition determined as an invalid partition is pruned off, and whether a next data partition in the database is a valid partition is determined until all data partitions in the database are determined.

In step S10, it is determined whether the condition result of the combination result is true. It should be noted that if the query condition includes multiple sub-conditions, condition results of all the sub-conditions need to be acquired. In some embodiments, if the condition results of the sub-conditions are all true, the LIST partition is determined as a valid partition; if the condition result of any one or more sub-conditions is false, the LIST partition is determined as an invalid partition.

Specifically, if the condition result of the combination result is determined as true, step S11 is executed; if the condition result of the combination result is determined as false, the invalid LIST partition is directly pruned off when the above LIST partition is determined as an invalid partition, and step S1 is executed to continue determining whether the query of all LIST partitions is completed.

The solution provided in the above optional embodiments achieves the aim of executing query without querying an invalid partition, thereby achieving the technical effect of improving query efficiency and further solving the existing technical problems of the difficulty in avoiding invalid partition query and the consequent low query efficiency.

It should be noted that, for the foregoing method embodiments, for simplicity of description, they are all described as a series of action combinations. However, those skilled in the art should know that the present disclosure is not limited by the sequence of actions described, because some steps can be performed in other orders or simultaneously according to the present disclosure. Secondly, those skilled in the art should also know that the embodiments described in the description are all preferred embodiments, and the actions and modules involved are not necessarily required by the present disclosure.

Through the description of the above embodiments, those skilled in the art can clearly understand that the method according to the above embodiments can be implemented by means of software plus a necessary universal hardware platform, and of course, can also be implemented by hardware, but in many cases, the former is a better implementation. Based on such an understanding, the technical solution of the present disclosure substantially or a part that contributes to the existing technology can be embodied in the form of a software product. The computer software product is stored in a storage medium (such as a ROM/RAM, a magnetic disk, or an optical disc), and includes a number of instructions for causing a terminal device (which can be a mobile phone, a computer, a server, or a network device) to execute methods of embodiments in the present disclosure.

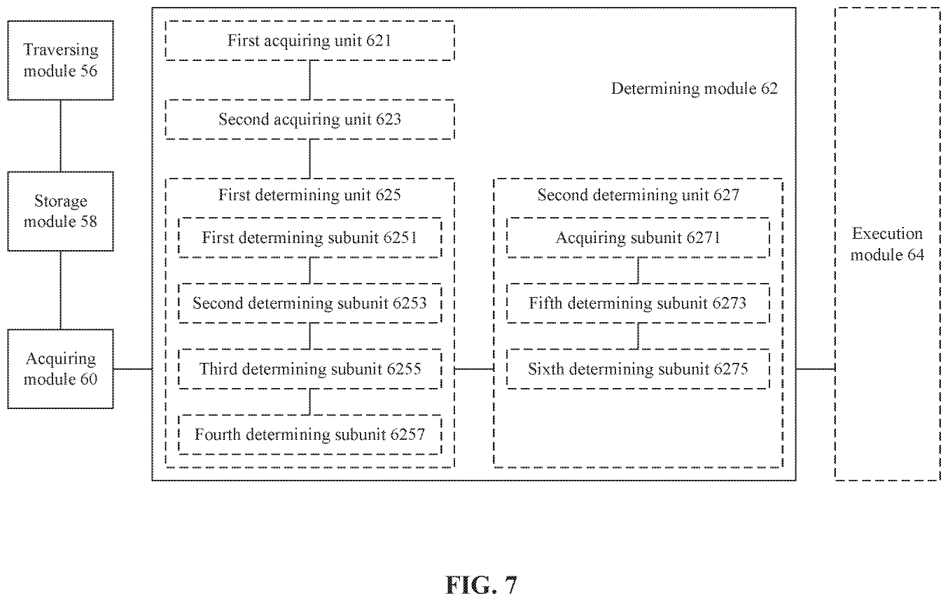

According to some embodiments of the present disclosure, an apparatus for implementing the method for evaluating a partition in a database is further provided. FIG. 7 is a schematic structural diagram of an exemplary apparatus for evaluating a partition in a database, consistent with some embodiments of the present disclosure. As shown in FIG. 7, the apparatus includes an acquiring module 60 and a determining module 62.

The acquiring module 60 is configured to acquire meta information of a data partition in the database, wherein the meta information includes an area range value of the data partition. The determining module 62 is configured to determine whether the data partition is a valid partition according to a query condition and the meta information of the data partition.

The acquiring module 60 and the determining module 62 correspond to steps S102 to S104 in Embodiment 2. The examples and application scenarios of the two modules and the corresponding steps are the same but are not limited to the content disclosed in the embodiments. It should be noted that, as a part of the apparatus, the above modules can be run in a computer terminal provided in some embodiments.

It can be known based on the solutions defined in the embodiments that in this disclosure, an acquiring module is set to acquire meta information of a data partition in the database, wherein the meta information includes an area range value of the data partition. A determining module is configured to determine whether the data partition is a valid partition according to a query condition and the meta information of the data partition.

Since meta information of a data partition in the database is increased when the LIST partition is created, the meta information of the data partition in the database is acquired when query is executed, and according to the meta information and a query condition, the partition number of an invalid partition that does not meet the condition can be determined, and the invalid partition is automatically pruned off; no DBA or user is required to be aware of the partition logic and manually change SQL, which can effectively improve query efficiency.

The solution provided in the above embodiments of this disclosure achieves the aim of executing query without querying an invalid partition, thereby achieving the technical effect of improving query efficiency and further solving the existing technical problems of the difficulty in avoiding invalid partition query and the consequent low query efficiency.

In some embodiments, as shown in FIG. 7, the determining module 62 includes a first acquiring unit 621, a second acquiring unit 623, a first determining unit 625, and a second determining unit 627.

The first acquiring unit 621 is configured to obtain, if the query condition is a combined condition, at least one sub-condition included in the combined condition. The second acquiring unit 623 is configured to acquire a condition value of the sub-condition according to the type of the sub-condition. The first determining unit 625 is configured to determine a condition result of the sub-condition by comparing the condition value of the sub-condition with the area range value of the data partition, wherein the area range value of the data partition at least includes a maximum area value and a minimum area value. The second determining unit 627 is configured to determine, based on the condition result of the at least one sub-condition, whether the data partition is a valid partition.

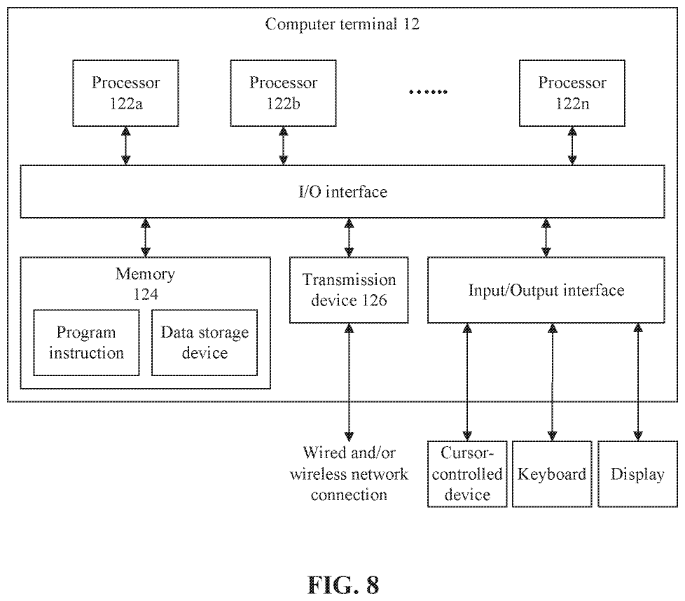

The first acquiring unit 621, the second acquiring unit 623, the first determining unit 625, and the second determining unit 627 correspond to Step S1041 to Step S1047. It should be noted that, as a part of the apparatus, the above modules can be run in the computer terminal of FIG. 8.

In some embodiments, if the type of the sub-condition is an equivalent condition, the condition value of the sub-condition is any preset value. As shown in FIG. 7, the first determining unit 625 includes a first determining subunit 6251 and a second determining subunit 6253.

The first determining subunit 6251 is configured to determine the condition result of the sub-condition as false if the maximum area value is less than or equal to the condition value of the sub-condition, or the minimum area value is greater than or equal to the condition value of the sub-condition. The second determining subunit 6253 is configured to determine the condition result of the sub-condition as true if the maximum area value is greater than the condition value of the sub-condition, or the minimum area value is less than the condition value of the sub-condition.

In some embodiments, if the type of the sub-condition is a range query condition, the condition value of the sub-condition is a preset range value. As shown in FIG. 7, the first determining unit 625 includes a third determining subunit 6255 and a fourth determining subunit 6257.

The third determining subunit 6255 is configured to determine, if there is an intersection between the preset range value and the area range value of the data partition, the condition result of the sub-condition as true. The fourth determining subunit 6257 is configured to determine, if there is no intersection between the preset range value and the area range value of the data partition, the condition result of the sub-condition as false.

In some embodiments, if the type of the sub-condition is neither an equivalent condition nor a range query condition, the condition result of the sub-condition is determined as true.

In some embodiments, as shown in FIG. 7, the second determining unit 627 includes an acquiring subunit 6271, a fifth determining subunit 6273, and a sixth determining subunit 6275.

The acquiring subunit 6271 is configured to acquire, if the query condition includes multiple sub-conditions, condition results of all the sub-conditions. The fifth determining subunit 6273 is configured to determine, if the condition results of the sub-conditions are all true, the data partition as a valid partition. The sixth determining subunit 6275 is configured to determine, if the condition result of any one or more sub-conditions is false, the data partition as an invalid partition.

The acquiring subunit 6271, the fifth determining subunit 6273, and the sixth determining subunit 6275 correspond to Step S10471 to Step S10475. It should be noted that, as a part of the apparatus, the above modules can be run in the computer terminal of FIG. 8

In some embodiments, as shown in FIG. 7, the apparatus also includes an execution module 64 configured to, if the data partition is determined as an invalid partition, directly prune off the invalid partition.

In some embodiments, as shown in FIG. 7, the apparatus also includes a traversing module 56 and a storage module 58.

The traversing module 56 is configured to traverse each data record in the database and acquire an area range value of each data record when data partitions of the database are created. The storage module 58 is configured to store the area range value of each data record into meta information of a corresponding data partition to obtain an area range value of the data partition.

The traversing module 56 and the storage module 58 correspond to Step S100 to Step S101 of FIG. 3. The examples and application scenarios of the two modules and the corresponding steps are the same but are not limited to the content disclosed in the embodiments. It should be noted that, as a part of the apparatus, the above module can be run in a computer terminal of FIG. 8.

In some embodiments, in the process of executing query language of the database, it is necessary to determine sequentially whether each data partition included in the database is a valid partition, and if the currently determined data partition is determined as a valid partition, a corresponding partition query is executed; otherwise, the data partition determined as an invalid partition is pruned off, and whether a next data partition in the database is a valid partition is determined until all data partitions in the database are determined.

Embodiments of the present disclosure can provide a computer terminal, and the computer terminal can be any computer terminal device in a computer terminal group. Optionally, in some embodiments, the computer terminal described above can also be replaced by a terminal device such as a mobile terminal.

Optionally, in some embodiments, the computer terminal can be located in at least one network device among multiple network devices in a computer network.

FIG. 8 is a hardware structural block diagram of a computer terminal. As shown in FIG. 8, the computer terminal 12 can include one or more (shown by 122a, 122b . . . 122n in the figure) processors 122 (the processor 122 can include, but is not limited to, a processing device such as a microprocessor MCU or a programmable logic device FPGA), a memory 124 for storing data, and a transmission device 126 for communication functions. In addition, it can also include: a display, an input/output interface (I/O interface), a universal serial bus (USB) port (can be included as one of the I/O interface ports), a network interface, a power or a camera. A person of ordinary skill in the art can understand that the structure shown in FIG. 8 is only schematic, and it does not limit the structure of the electronic device. For example, the computer terminal 12 can further include more or fewer components than those shown in FIG. 8, or have a different configuration from that shown in FIG. 8.

It should be noted that the one or more processors 122 or other data processing circuits described above can generally be referred to herein as “data processing circuits.” The data processing circuit can be fully or partially embodied as software, hardware, firmware, or any other combination. In addition, the data processing circuit can be a single independent processing module, or any one of other elements incorporated in the computer terminal 12 in whole or in part. As mentioned in the embodiment of this disclosure, the data processing circuit is controlled as a processor (for example, selection of a variable resistance terminal path connected to an interface).

The processor 122 can invoke, via a transmission device, information and applications stored in the memory to execute the following steps: acquiring meta information of a data partition in a database, wherein the meta information includes an area range value of the data partition; and determining whether the data partition is a valid partition according to a query condition and the meta information of the data partition.

The memory 124 can be used to store software programs and modules of application software, such as a program instruction/data storage device corresponding to a method for determining a valid partition in a database in the embodiment of this disclosure. The processor 122 executes various functional applications and data processing by running software programs and modules stored in the memory 124, that is, implementing the method for determining a valid partition in a database. The memory 124 can include a high-speed random access memory, and can further include a non-volatile memory, such as one or more magnetic storage devices, a flash memory, or other non-volatile solid-state memories. In some examples, the memory 124 can further include memories remotely disposed with respect to the processor 122, and these remote memories can be connected to the computer terminal 12 through a network. Examples of the above network include, but are not limited to, the Internet, an intranet, a local area network, a mobile communication network, and combinations thereof.

The transmission device 126 is used for receiving or transmitting data via a network. A specific example of the above network can include a wireless network provided by a communication provider of the computer terminal 12. In one example, the transmission device 126 includes a network adapter (Network Interface Controller, NIC), which can be connected to other network equipment through a base station so as to communicate with the Internet. In one example, the transmission device 126 can be a Radio Frequency (RF) module, which is used to communicate with the Internet in a wireless manner.

The display can be, for example, a liquid crystal display (LCD) of a touch screen type, which can enable a user to interact with a user interface of the computer terminal 12.

It should be noted here that, in some optional embodiments, the computer terminal 12 shown in FIG. 8 above can include hardware elements (including circuits), software elements (including computer code stored on a computer-readable medium), or a combination of both hardware and software elements. It should be noted that FIG. 8 is only one example of a specific example, and is intended to illustrate the types of components that can be present in the computer terminal 12 described above.

In some embodiments, the computer terminal can execute program codes of the following steps in the method for determining a valid partition in a database: acquiring meta information of a data partition in a database, wherein the meta information includes an area range value of the data partition; and determining whether the data partition is a valid partition according to a query condition and the meta information of the data partition.

The processor can invoke, via a transmission device, information and applications stored in the memory to execute the following steps: acquiring meta information of a data partition in a database, wherein the meta information includes an area range value of the data partition; and determining whether the data partition is a valid partition according to a query condition and the meta information of the data partition.

Optionally, the processor can also execute program codes of the following steps: obtaining, if the query condition is a combined condition, at least one sub-condition included in the combined condition; acquiring a condition value of the sub-condition according to the type of the sub-condition; determining a condition result of the sub-condition by comparing the condition value of the sub-condition with the area range value of the data partition, wherein the area range value of the data partition at least includes a maximum area value and a minimum area value; and determining, based on the condition result of the at least one sub-condition, whether the data partition is a valid partition.

Optionally, the processor can also execute program codes of the following step: determining the condition result of the sub-condition as false if the maximum area value is less than or equal to the condition value of the sub-condition, or the minimum area value is greater than or equal to the condition value of the sub-condition; otherwise, determining the condition result of the sub-condition as true.

Optionally, the processor can also execute program codes of the following step: determining, if there is an intersection between the preset range value and the area range value of the data partition, the condition result of the sub-condition as true; otherwise, determining the condition result of the sub-condition as false.

Optionally, the processor can also execute program codes of the following step: if the type of the sub-condition is neither an equivalent condition nor a range query condition, the condition result of the sub-condition is determined as true.

Optionally, the processor can also execute program codes of the following steps: if the query condition includes multiple sub-conditions, acquiring a condition result of each of the sub-conditions; determining, if the condition results of the sub-conditions are all true, the data partition as a valid partition; and determining, if the condition result of any one or more sub-conditions is false, the data partition as an invalid partition.

Optionally, the processor can also execute program codes of the following step: if the data partition is determined as an invalid partition, directly pruning off the invalid partition.

Optionally, the processor can also execute program codes of the following steps: traversing each data record in a database and acquiring an area range value of each data record when creating data partitions of the database; and storing the area range value of each data record into meta information of a corresponding data partition to obtain an area range value of the data partition.

Optionally, the processor can also execute program codes of the following steps: in the process of executing query language of the database, it is necessary to determine sequentially whether each data partition included in the database is a valid partition, and if the currently determined data partition is determined as a valid partition, a corresponding partition query is executed; otherwise, the data partition determined as an invalid partition is pruned off, and whether a next data partition in the database is a valid partition is determined until all data partitions in the database are determined.

Some embodiments of the present disclosure is used to provide a solution for determining a valid partition in a database. Meta information of a data partition in a database is acquired, wherein the meta information includes an area range value of the data partition; and it is determined, according to a query condition and the meta information of the data partition, whether the data partition is a valid partition, which achieves the aim of executing query without querying an invalid partition, thereby achieving the technical effect of improving query efficiency and further solving the existing technical problems of the difficulty in avoiding invalid partition query and the consequent low query efficiency.

A person of ordinary skill in the art can understand that the structure shown in FIG. 8 is only schematic, and the computer terminal can also be a smart phone (such as an Android phone, an iOS phone, etc.), a tablet computer, a palmtop computer, and a Mobile Internet Device (MID), PAD or other terminal devices. FIG. 8 does not limit the structure of the electronic device. For example, the computer terminal 12 can further include more or less components (such as a network interface, a display device, etc.) than those shown in FIG. 8, or have a configuration different from that shown in FIG. 8.

It is appreciated that all or some of the procedures in the methods of the foregoing embodiments can be implemented by a program instructing relevant hardware components of a terminal device (for example, computer terminal 12 of FIG. 8). The program can be stored in a computer readable storage medium. The storage medium includes a flash memory, a Read-Only Memory (ROM), a Random Access Memory (RAM), a magnetic disk, or an optical disc.

In some embodiments, a non-transitory computer-readable storage medium including instructions is also provided, and the instructions may be executed by a device (such as computer terminal 12 of FIG. 8), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, or a memory.

Optionally, in some embodiments, the storage medium can be located in any computer terminal in a computer terminal group in a computer network, or in any mobile terminal in a mobile terminal group.

Optionally, in some embodiments, the storage medium is set to store program codes for executing the following steps: acquiring meta information of a data partition in the database, wherein the meta information includes an area range value of the data partition; and determining whether the data partition is a valid partition according to a query condition and the meta information of the data partition.

Optionally, in some embodiments, the storage medium is set to store program codes for executing the following steps: obtaining, if the query condition is a combined condition, at least one sub-condition included in the combined condition; acquiring a condition value of the sub-condition according to the type of the sub-condition; determining a condition result of the sub-condition by comparing the condition value of the sub-condition with the area range value of the data partition, wherein the area range value of the data partition at least includes a maximum area value and a minimum area value; and determining, based on the condition result of the at least one sub-condition, whether the data partition is a valid partition.

Optionally, in some embodiments, the storage medium is set to store program codes for executing the following step: determining the condition result of the sub-condition as false if the maximum area value is less than or equal to the condition value of the sub-condition, or the minimum area value is greater than or equal to the condition value of the sub-condition; otherwise, determining the condition result of the sub-condition as true.

Optionally, in some embodiments, the storage medium is set to store program codes for executing the following step: determining, if there is an intersection between the preset range value and the area range value of the data partition, the condition result of the sub-condition as true; otherwise, determining the condition result of the sub-condition as false.

Optionally, in some embodiments, the storage medium is set to store program codes for executing the following step: if the type of the sub-condition is neither an equivalent condition nor a range query condition, the condition result of the sub-condition is determined as true.

Optionally, in some embodiments, the storage medium is set to store program codes for executing the following steps: if the query condition includes multiple sub-conditions, acquiring a condition result of each of the sub-conditions; determining, if the condition results of the sub-conditions are all true, the data partition as a valid partition; and determining, if the condition result of any one or more sub-conditions is false, the data partition as an invalid partition.

Optionally, in some embodiments, the storage medium is set to store program codes for executing the following step: if the data partition is determined as an invalid partition, directly pruning off the invalid partition.

Optionally, in some embodiments, the storage medium is set to store program codes for executing the following steps: traversing each data record in a database and acquiring an area range value of each data record when creating data partitions of the database; and storing the area range value of each data record into meta information of a corresponding data partition to obtain an area range value of the data partition.

Optionally, in some embodiments, the storage medium is set to store program codes for executing the following steps: in the process of executing query language of the database, it is necessary to determine sequentially whether each data partition included in the database is a valid partition, and if the currently determined data partition is determined as a valid partition, a corresponding partition query is executed; otherwise, the data partition determined as an invalid partition is pruned off, and whether a next data partition in the database is a valid partition is determined until all data.

Based on the several embodiments provided in the present disclosure, it should be appreciated that the disclosed technical contents may be implemented in another manner. The described apparatus, system, and method embodiments are only exemplary. For example, division of units or modules are merely exemplary division based on the logical functions. Division in another manner may exist in actual implementation. Further, a plurality of units or components may be combined or integrated into another system. Some features or components may be omitted or modified in some embodiments. In addition, the mutual coupling or direct coupling or communication connections displayed or discussed may be implemented by using some interfaces. The indirect coupling or communication connections between the units or modules may be implemented electrically or in another form.

Further, the units described as separate parts may or may not be physically separate. Parts displayed as units may or may not be physical units. They may be located in a same location or may be distributed on a plurality of network units. Some or all of the units may be selected according to actual needs to achieve the objectives of the solutions of the embodiments. In addition, functional units in the embodiments of the present disclosure may be integrated into one processing unit. Each of the units may exist alone physically, or two or more units can be integrated into one unit. The integrated unit may be implemented in a form of hardware or may be implemented in a form of a software functional unit.

It is appreciated that the above described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

The embodiments of the present disclosure are described with reference to flowcharts or block diagrams of the method, the terminal device (system) and the computer program product. It should be understood that a computer program instruction can be used to implement each process or block in the flowcharts or block diagrams and combinations of processes or blocks in the flowcharts or block diagrams. The computer program instructions can be provided to a general-purpose computer, a special-purpose computer, an embedded processor or a processor of another programmable data processing terminal device to generate a machine, such that the computer or the processor of another programmable data processing terminal device executes an instruction to generate an apparatus configured to implement functions designated in one or more processes in a flowchart or one or more blocks in a block diagram.

The computer program instructions can also be stored in a computer readable storage that can guide the computer or another programmable data processing terminal device to work in a specific manner, such that the instruction stored in the computer readable storage generates an article of manufacture including an instruction apparatus, and the instruction apparatus implements functions designated by one or more processes in a flowchart or one or more blocks in a block diagram.

The computer program instructions can also be loaded into the computer or another programmable data processing terminal device, such that a series of operation steps are executed on the computer or another programmable terminal device to generate a computer implemented processing, and therefore, the instruction executed in the computer or another programmable terminal device provides steps for implementing functions designated in one or more processes in a flowchart or one or more blocks in a block diagram.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the embodiments disclosed herein. It is intended that the specification and examples be considered as exemplary only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the database may include A, or B, or C, or A and B, or A and C, or B and C, or A and B and C.

It is appreciated that the above descriptions are only exemplary embodiments provided in the present disclosure. Consistent with the present disclosure, those of ordinary skill in the art may incorporate variations and modifications in actual implementation, without departing from the principles of the present disclosure. Such variations and modifications shall all fall within the protection scope of the present disclosure.

1. A method for evaluating a partition in a database, comprising:
acquiring meta information of a data partition in the database, wherein the meta information comprises an area range value of the data partition; and
determining whether the data partition is a valid partition according to a query condition of a query associated with the data partition and the meta information of the data partition.

2. The method according to claim 1, wherein determining whether the data partition is a valid partition according to the query condition and the meta information of the data partition comprises:
obtaining, in response to the query condition being a combined condition, a sub-condition of the combined condition;
acquiring a condition value of the sub-condition according to a type of the sub-condition;
determining a condition result of the sub-condition by comparing the condition value of the sub-condition with the area range value of the data partition, wherein the area range value of the data partition comprises: a maximum area value and a minimum area value; and
determining, based on the condition result of the sub-condition, whether the data partition is a valid partition.

3. The method according to claim 2, wherein the type of the sub-condition is an equivalent condition, determining the condition result of the sub-condition by comparing the condition value of the sub-condition with the area range value of the data partition comprises:
in response to one of the maximum area value being less than or equal to the condition value of the sub-condition, or the minimum area value being greater than or equal to the condition value of the sub-condition, determining that the condition result of the sub-condition is false; and
in response to both of the condition value of the sub-condition being greater than the minimum area value and the condition value of the sub-condition being less than or equal to the maximum area value, determining that the condition result of the sub-condition is true.

4. The method according to claim 2, wherein the type of the sub-condition is a range query condition, and the determining the condition result of the sub-condition by comparing the condition value of the sub-condition with the area range value of the data partition comprises:
in response to the condition value overlapping the area range value, determining that the condition result of the sub-condition is true; or
in response to the condition value not overlapping the area range value, determining that the condition result of the sub-condition is false.

5. The method according to claim 2, wherein the type of the sub-condition is not any one of an equivalent condition or a range query condition,
determining that the condition result of the sub-condition is true.

6. The method according to of claim 2, wherein determining, based on the condition result of the sub-condition, whether the data partition is a valid partition comprises:
acquiring the condition result of the sub-condition;
in response to the condition result of the sub-condition being false, determining that the data partition is an invalid partition; or
in response to the condition result of the sub-condition being true, determining whether a condition result of a next sub-condition of the combined condition is true.

7. The method according to claim 1, wherein after determining whether the data partition is a valid partition according to the query condition and the meta information of the data partition, the method further comprises:
in response to the data partition being an invalid partition, pruning off the invalid partition.

8. The method according to claim 1, wherein before acquiring the meta information of the data partition in the database, the method further comprises:
traversing each data record in the database and acquiring the area range value of each data record of the data partition when creating the data partition of the database; and
storing the area range value of each data record of the data partition into the meta information of the data partition to enable the area range value of the data partition being determined based on the area range value of each data record of the data partition.

9. The method according to claim 1, wherein further comprising:
in response to the data partition being a valid partition, executing the query associated with the data partition; or
in response to the data partition being an invalid partition, pruning off the data partition, and determining whether a next data partition in the database is a valid partition.

10. An apparatus for evaluating a partition in a database, comprising:
a memory storing a set of instructions; and
one or more processors configured to execute the set of instruction to cause the apparatus to perform:
acquiring meta information of a data partition in the database, wherein the meta information comprises an area range value of the data partition, and
determining whether the data partition is a valid partition according to a query condition of a query associated with the data partition and the meta information of the data partition.

11. The apparatus of claim 10, wherein determining whether the data partition is a valid partition according to the query condition and the meta information of the data partition comprises:
obtaining, in response to the query condition being a combined condition, a sub-condition of the combined condition;
acquiring a condition value of the sub-condition according to a type of the sub-condition;
determining a condition result of the sub-condition by comparing the condition value of the sub-condition with the area range value of the data partition, wherein the area range value of the data partition comprises: a maximum area value and a minimum area value; and
determining, based on the condition result of the sub-condition, whether the data partition is a valid partition.

12-18. (canceled)

19. A non-transitory computer readable medium that stores a set of instructions that is executable by at least one processor of a computer to cause the computer to perform a method for evaluating a partition in a database, the method comprising:
acquiring meta information of a data partition in the database, wherein the meta information comprises an area range value of the data partition; and
determining whether the data partition is a valid partition according to a query condition of a query associated with the data partition and the meta information of the data partition.

20. The non-transitory computer readable medium of claim 19, wherein determining whether the data partition is a valid partition according to the query condition and the meta information of the data partition comprises:
obtaining, in response to the query condition being a combined condition, a sub-condition of the combined condition;
acquiring a condition value of the sub-condition according to a type of the sub-condition;
determining a condition result of the sub-condition by comparing the condition value of the sub-condition with the area range value of the data partition, wherein the area range value of the data partition comprises: a maximum area value and a minimum area value; and
determining, based on the condition result of the sub-condition, whether the data partition is a valid partition.

21. The non-transitory computer readable medium of claim 20, wherein the type of the sub-condition is an equivalent condition, determining the condition result of the sub-condition by comparing the condition value of the sub-condition with the area range value of the data partition comprises:
in response to one of the maximum area value being less than or equal to the condition value of the sub-condition, or the minimum area value being greater than or equal to the condition value of the sub-condition, determining that the condition result of the sub-condition is false; and
in response to both of the condition value of the sub-condition being greater than the minimum area value and the condition value of the sub-condition being less than or equal to the maximum area value, determining that the condition result of the sub-condition is true.

22. The non-transitory computer readable medium of claim 20, wherein the type of the sub-condition is a range query condition, and the determining the condition result of the sub-condition by comparing the condition value of the sub-condition with the area range value of the data partition comprises:
in response to the condition value overlapping the area range value, determining that the condition result of the sub-condition is true; and
in response to the condition value not overlapping the area range value, determining that the condition result of the sub-condition is false.

23. The non-transitory computer readable medium of claim 20, wherein the type of the sub-condition is not any one of an equivalent condition or a range query condition,
determining that the condition result of the sub-condition is true.

24. The non-transitory computer readable medium of claim 20, wherein
determining, based on the condition result of the sub-condition, whether the data partition is a valid partition comprises:
acquiring the condition results of all of the plurality of sub-conditions;
in response to the condition result of the sub-condition being false, determining that the data partition is an invalid partition; or
in response to the condition result of the sub-condition being true, determining whether a condition result of a next sub-condition of the combined condition is true.

25. The non-transitory computer readable medium of claim 19, wherein after determining whether the data partition is a valid partition according to the query condition and the meta information of the data partition, the set of instructions that are executable by the at least one processor of a computer to cause the computer to further perform:
in response to the data partition being an invalid partition, pruning off the invalid partition.

26. The non-transitory computer readable medium of claim 19, wherein before acquiring the meta information of the data partition in the database, the set of instructions that are executable by the at least one processor of a computer to cause the computer to further perform:
traversing each data record in the database and acquiring the area range value of each data record of the data partition when creating the data partition of the database; and
storing the area range value of each data record of the data partition into the meta information of the data partition to enable the area range value of the data partition being determined based on the area range value of each data record of the data partition.

27. The non-transitory computer readable medium of claim 19, wherein the set of instructions that are executable by the at least one processor of a computer to cause the computer to further perform:
in response to the data partition being a valid partition, executing the query associated with the data partition; or
in response to the data partition being an invalid partition, pruning off the data partition, and determining whether a next data partition in the database is a valid partition.

28. (canceled)
